(19) United States
(12) Patent Application Publication
(10) Pub. No.: US 2008/0190492 A1
(43) Pub. Date: Aug. 14, 2008

(54) Outlet Fitting for a High-Pressure Pump

(76) Inventors: Walter Fuchs, Stuttgart (DE); Andreas Dutt, Stuttgart (DE); Waldemar Kiel, Gerlingen (DE); Jochen Aleker, Stuttgart (DE); Arnold Gente, Stuttgart (DE); Angelo Santamaria, Esslingen (DE); Wolfgang Majer, Moessingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/914,412

(22) PCT Filed: Apr. 3, 2006
(86) PCT No.: PCT/EP06/61266

§ 371 Date: Nov. 14, 2007

(30) Foreign Application Priority Data
May 25, 2005 (DE) 10 2005 024 042.9

(51) Int. Cl. F16K 15/02; F04B 39/10

(52) U.S. Cl. 137/540; 251/337; 417/559

(57) ABSTRACT

The invention relates to an outlet connection of a fluid high-pressure light, in particular a high-pressure line for fuel, and comprises an outlet bore, an outlet valve that is situated in said bore, the valve element of which can be displaced in said bore and can be controlled by the pressure prevailing in the high-pressure line in opposition to the action of a spring element, a spring retainer inserted into the outlet bore and fixed in the latter and on which the spring element is supported, and an external thread.

### PRIOR ART

The invention relates to an outlet fitting of a pressurized fluid liner in particular a high-pressure fuel line of a high-pressure piston pump.

FIG. 4. shows a high-pressure piston pump 20 according to the prior art. The cylinder head 21 of the high-pressure pump 20 is provided with an outlet fitting 22, an outlet bore 23, and an outlet valve 24 integrated into the outlet bore 23. A thread adapter 26 that has a customer-specific external thread 27 at its other end is screwed into an internal thread 25 of the outlet bore 23. The outlet valve 24 includes a valve ball 28 that is guided in a sliding fashion in the outlet bore 23 and is pressed into contact with a conical valve seat 30 of the outlet bore 23 by a valve spring 29. The valve spring 29 rests against the thread adapter 26, whose end surface 31 constitutes a stop for the opening motion of the valve ball 28. The outlet valve 24 seals off the high-pressure supply chamber 33 of the high-pressure pump 20, which is delimited by a piston 32, as well as the pressure line 34 leading from this chamber to the valve seat 30 and opens when the pressure prevailing therein is sufficient to open the valve ball 28 counter to the action of the valve spring 29.

### ADVANTAGES OF THE INVENTION

The outlet fitting according to the invention, with the defining characteristics of claim 1, has the following advantages over the prior art:
complete integration of all valve components into the outlet fitting;
the customer-specific connection thread is provided on the outlet fitting, which results in reduced stresses due to the action of internal pressure, thus yielding higher component strength;
significant reduction in overall length, yielding material savings and resulting in an improved situation when mounted on the engine;
no need for thread adapter with two different threads;
elimination of the seal location that was previously required between the thread adapter and outlet fitting;
no danger of the customer inadvertently loosening or further rotating the thread adapter during line assembly, disassembly, and reassembly.

In particular, the outlet fitting according to the invention can be used to seal the high-pressure supply chamber in high-pressure pumps.

Other advantages and advantageous embodiments of the subject of the invention can be inferred from the description, the drawings, and the claims.

### DRAWINGS

Exemplary embodiments of the outlet fitting according to the invention are shown in the drawings and will be explained in detail in the subsequent description.

FIG. 1 shows a first exemplary embodiment of the outlet fitting according to the invention in the example of a high-pressure piston pump;

FIG. 2 shows a second exemplary embodiment of the outlet fitting according to the invention in an enlarged depiction of the detail II in FIG. 1;

FIG. 3 shows a third exemplary embodiment of the outlet fitting according to the invention in an enlarged depiction of the detail II in FIG. 1; and

FIG. 4 shows the outlet fitting of a high-pressure piston pump according to the prior art.

### DESCRIPTION OF THE EXEMPLARY EMBODIMENTS

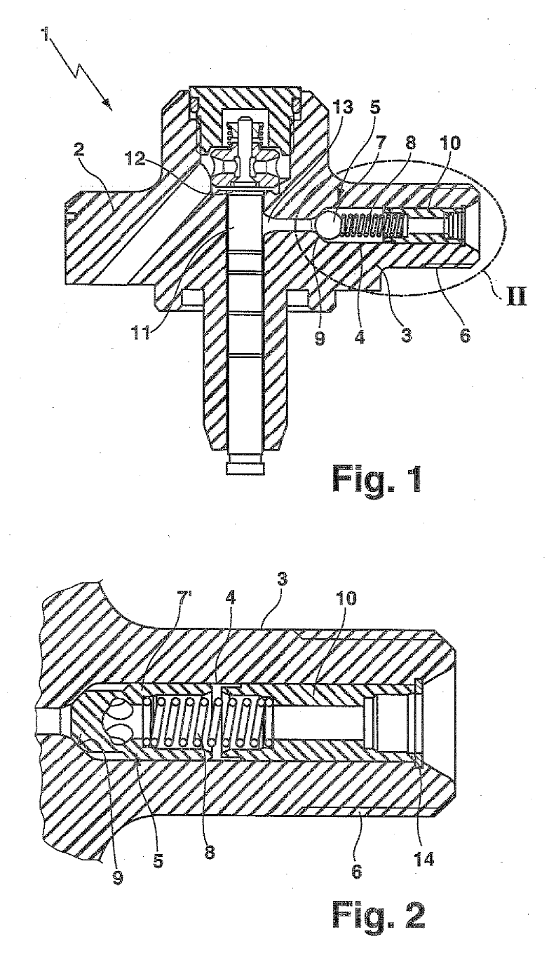

FIG. 1 shows a hydraulic high-pressure piston pump 1 of a fuel injection apparatus for an internal combustion engine. The cylinder head 2 of piston pump is provided with an outlet fitting 3, which is provided with an outlet bore 4, an outlet valve 5 integrated into the outlet bore 4, and a customer-specific external thread 6. The outlet valve 5 includes a valve ball 7 that is guided in a sliding fashion in the outlet bore 4 and is pressed into contact with a conical valve seat 9 of the outlet bore 4 by a valve spring 8. The valve spring 8 rests against a sleeve-shaped spring retainer 10 that is inserted all the way into the outlet bore 4 and press-fitted therein. Alternatively, the spring retainer 10 can also be screwed into the outlet bore 4 or fixed in position therein by welding. The outlet valve 5 seals off the high-pressure supply chamber 12 of the high-pressure pump 1, which is delimited by a piston 11, as well as the high-pressure line 13 leading from this chamber to the valve seat 9 and opens when the pressure prevailing therein is sufficient to open the valve ball 7 counter to the action of the valve spring 8.

The outlet fitting 3 shown in FIG. 2 differs from the one in FIG. 1 only in that the valve ball has been replaced by a valve piston or valve dome 7′ with a conical or dome-shaped valve-sealing surface and the spring retainer 10 is fixed in position in the outlet bore 4 by means of securing ring 14 that is inserted into an annular groove in the outlet bore 4. The guidance diameter of the outlet bore 4 for the valve piston 7′ here simultaneously functions as the guidance diameter for the spring retainer 10, thus allowing two precision diameters to be manufactured in one work step. The guidance diameter is machined in the same set-up as the valve seat 9. This yields very good positional tolerances (axial runout, coaxiality) that assure a high quality of the outlet valve.

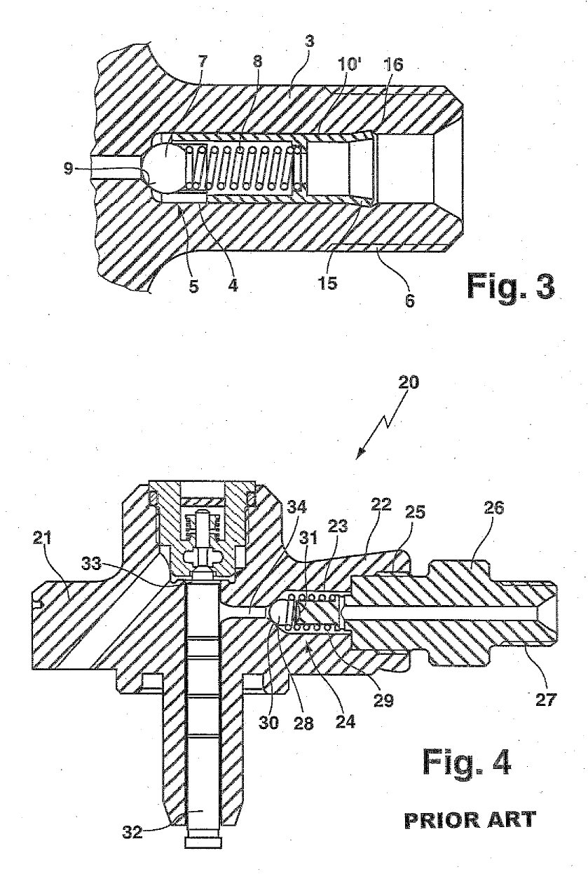

The outlet fitting 3 shown in FIG. 3 differs from the one in FIG. 1 only in that the rear end of the spring retainer 10′ with regard to its insertion direction is provided with detent projections, e.g. bent sheet-metal tabs, 15 that engage in detent fashion behind an annular shoulder 16 of the outlet bore 4, i.e. are fixed in position in the outlet bore 4 by means of form-locked engagement.

1-11. (canceled)

12. An outlet fitting of a pressurized fluid line, in particular a high-pressure fuel line, the fitting comprising a valve body, an outlet bore in the valve body, an outlet valve that is contained in the outlet bore and includes a valve element guided in a sliding fashion in the outlet bore, a valve spring normally urging the valve element to a closed position, the valve element having the capacity to be opened by the pressure prevailing in the pressure line counter to the action of the spring element, a spring retainer inserted into the outlet bore and fixed in position therein, against which the spring element rests, and an external connection thread.

13. The outlet fitting according to claim 12, wherein the spring retainer is inserted all the way into the outlet bore.

14. The outlet fitting according to claim 12, wherein the spring retainer is press-fitted or screwed into the outlet bore.

15. The outlet fitting according to claim 13, wherein the spring retainer is press-fitted or screwed into the outlet bore.

16. The outlet fitting according to claim 12, wherein the spring retainer is welded to the outlet fitting.

17. The outlet fitting according to claim 13, wherein the spring retainer is welded to the outlet fitting.

18. The outlet fitting according to claim 12, wherein the spring retainer is fixed in position in the outlet bore by means of a securing ring that is inserted into an annular groove in the outlet bore.

19. The outlet fitting according to claim 13, wherein the spring retainer is fixed in position in the outlet bore by means of a securing ring that is inserted into an annular groove in the outlet bore.

20. The outlet fitting according to claim 12, wherein the spring retainer is fixed in position in the outlet bore by means of form-locked engagement by engaging in detent fashion behind an annular shoulder of the outlet bore.

21. The outlet fitting according to claim 13, wherein the spring retainer is fixed in position in the outlet bore by means of form-locked engagement by engaging in detent fashion behind an annular shoulder of the outlet bore.

22. The outlet fitting according to claim 12, wherein the spring element is embodied in the form of a valve spring.

23. The outlet fitting according to claim 13, wherein the spring element is embodied in the form of a valve spring.

24. The outlet fitting according to claim 12, wherein the outlet bore has a valve seat that cooperates with the valve element.

25. The outlet fitting according to claim 13, wherein the outlet bore has a valve seat that cooperates with the valve element.

26. The outlet fitting according to claim 12, wherein the valve element is a valve ball, a valve piston, a valve cone, a valve plate, or a valve dome.

27. The outlet fitting according to claim 13, wherein the valve element is a valve ball, a valve piston, a valve cone, a valve plate, or a valve dome.

28. The outlet fitting according to claim 12, wherein the guidance diameter of the outlet bore for the valve element simultaneously serves as the guidance diameter for the spring retainer.

29. The outlet fitting according to claim 13, wherein the guidance diameter of the outlet bore for the valve element simultaneously serves as the guidance diameter for the spring retainer.

30. The outlet fitting according to claim 14, wherein the guidance diameter of the outlet bore for the valve element simultaneously serves as the guidance diameter for the spring retainer.

31. A high-pressure piston pump of a fuel injection apparatus for an internal combustion engine comprising an outlet fitting according to claim 12.
